(19) United States
(12) Patent Application Publication
(10) Pub. No.: US 2013/0186882 A1
(43) Pub. Date: Jul. 25, 2013

(54) TEMPERATURE CONTROL METHOD FOR A HEATING LINE

(71) Applicant: Ching-Chuan WANG, Keelung (TW)

(72) Inventor: Ching-Chuan WANG, Keelung (TW)

(21) Appl. No.: 13/356,119

(22) Filed: Jan. 23, 2012

(51) Int. Cl. H05B 1/02

(52) U.S. Cl. 219/497

(57) ABSTRACT

A temperature control method for a heating line comprises steps of: inputting continuous and changing pulse wave signals produced by the heating of a heating wire and reference pulse wave signals into a And-gate; utilizing the And-gate to obtain continuous synthesized pulse wave signals each of which has a pulse width that spans from a time point in which a logic high state begins to a time point in which the logic high state terminates; and controlling the control circuit to stop the heating of the heating wire when the time point in which the logic high state begins moves in relative to the time point in which the logic high state terminates and the pulse width of the synthesized pulse wave signals reaches a value preset by the processor, so as to keep the temperature within a preset and prevent overheat.

### TECHNICAL FIELD

The present invention relates to a temperature control method for a heating line and, more particularly, to a temperature control method for a heating line, which is capable of controlling the temperature effectively and adjusting the working temperature and is suitable for heaters such as electrothermal furnaces and heating pads for hot compression.

### BACKGROUND

Heaters such as heating pads are widely available in the market currently. Usually, the heating of a heating line will be automatically interrupted on condition that the temperature reaches a certain value preset by users. Thereby, the temperature of the heaters can be kept within a preset range in order to provide functions such as hot compression while ensure the safety of the users.

In order to control temperature effectively, as described in a US patent (U.S. Pat. No. 5,861,610), an element of positive temperature coefficient (abbreviated as PTC hereinafter) is used as a detection line. As described in a US patent (U.S. Pat. No. 6,943,327), an element of negative temperature coefficient (abbreviated as NTC hereinafter) is used as a detection line for sensing the temperature change, and consequently the element can be used together with a heating line for temperature-controlled heating. In this case, when the temperature of the detection line increases with the temperature of the heating line or the resistance of the detection line changes as a result of the high temperature, the comparison will occurs in the comparison circuit of the processor. On the basis of the comparison result, the current flowing into the heating line is adjusted so as to control and keep the temperature within a range preset by users.

Another US patent (U.S. Pat. No. 7,180,037) disclosed other application examples of PTC elements or NTC elements. In this patent, the technical feature distinguished from above conventional techniques is as follows: a first zero cross signal in response to the detection of a zero crossing of the AC power signal; a second zero cross signal in response to the zero crossing of the phase shifted AC power signal produced by detecting that the resistor of a PTC or NTC element is changed due to temperature; a time difference determinator circuit used to measure the phase-shift time of the first zero cross signal and the second zero cross signal continually; a controller used for calculation and outputting a control signal to render the circuit in conducting or disconnecting state; consequently, the temperature of the heating can be kept within a certain range.

The whole circuit configuration disclosed in above US patent (U.S. Pat. No. 7,180,037) is quiet complicated. Moreover, the temperature-control function can be performed only by the detection and calculation of the time difference determinator circuit and the controller. However, the manufacturing cost is inevitably increased.

In order to overcome above shortcomings, inventor had the motive to study and develop the present invention to provide a temperature control method for a heating line, which is distinguished from above prior arts and have advantages of effectively controlling temperature, simplifying the structure, and reducing the manufacturing cost.

### SUMMARY OF THE DISCLOSURE

An object of the present invention is to provide a temperature control method for a heating line, where it is capable of forming synthesized pulse wave signals from the continuous and changing pulse wave signals produced by the heated heating wire and the continuous reference pulse wave signals. Besides, by means of detecting the pulse width of the synthesized pulse wave signals, it is able to control the heating of the heating wire in order to keep the temperature within a preset range. Moreover, it is also able to simplify the structure and consequently reduce the manufacturing cost.

Another object of the present invention is to provide a temperature control method for a heating line, where it is capable of adjusting the time point in which the logic high state terminates for continuous reference pulse wave signals, so as to stop the heating of the heating wire. Thereby, it is easy for users to adjust the working temperature of the heating line.

In order to achieve above objects, the present invention provides a temperature control method for a heating line, where the heating line includes a heating wire and an insulation-and-meltable layer covering the peripheries of the heating wire; one end of the heating wire is coupled with one polarity of a power while another end of the heating wire is coupled with a switch, and the switch is coupled with a reverse polarity of the power; the switch is in conducting or disconnecting condition by means of the control of a control circuit having a processor; the temperature control method comprising steps of: a. having the power output continuous reference pulse wave signals via a pulse wave output circuit; b. utilizing a pulse wave detection circuit to detect continuous and changing pulse wave signals produced according to the temperature change of the heating wire during the heating process of the heating wire; c. utilizing an And-gate to obtain continuous synthesized pulse wave signals from the continuous reference pulse wave signals and the continuous and changing pulse wave signals, where each synthesized pulse wave signal has a pulse width that spans from a time point in which a logic high state begins to a time point in which the logic high state terminates; and d. controlling the control circuit to stop triggering the switch so as to stop the heating of the heating wire when the time point in which the logic high state begins moves in relative to the time point in which the logic high state terminates during the heating process of the heating wire and when the pulse width of the synthesized pulse wave signals reaches a value preset by the processor.

In implementation, the heating line is a positive temperature coefficient (PTC) or a negative temperature coefficient (NTC).

In implementation, in step b, the pulse wave detection circuit utilizes a temperature sensing element to detect the temperature change of the heating wire, so as to produce continuous and changing pulse wave signals by means of voltage comparison.

In implementation, the temperature sensing element is a sensing line or a thereto-sensitive resistor.

In implementation, the present invention further comprises a step for temperature adjustment by means of adjusting the time point in which the logic high state terminates for any reference pulse wave signal in order to stop the heating of the heating wire.

The following detailed description, given by way of examples or embodiments, will best be understood in conjunction with the accompanying drawings.

### BRIEF DESCRIPTION OF THE DRAWINGS

FIG. 1 is flow chart showing the steps of the present invention.

FIG. 2 is a circuit block diagram of the present invention.

FIG. 3 is a schematic view showing the change of the pulse width of the pulse waves synthesized from the output pulse waves from the pulse wave output circuit and the pulse wave detection circuit according to the present invention.

FIG. 4 is a circuit diagram of an embodiment of the present invention.

FIG. 5 is a schematic view showing the change of the output waveform from the pulse wave output circuit of the present invention.

FIG. 6 is a schematic view showing the change of the output waveform from the pulse wave detection circuit of the present invention.

FIG. 7 is a circuit diagram of another embodiment of the present invention.

FIG. 8 is a schematic view showing the change of the pulse width of the pulse waves synthesized from the output pulse waves from the pulse wave output circuit and the pulse wave detection circuit shown in FIG. 7.

### DETAILED DESCRIPTION

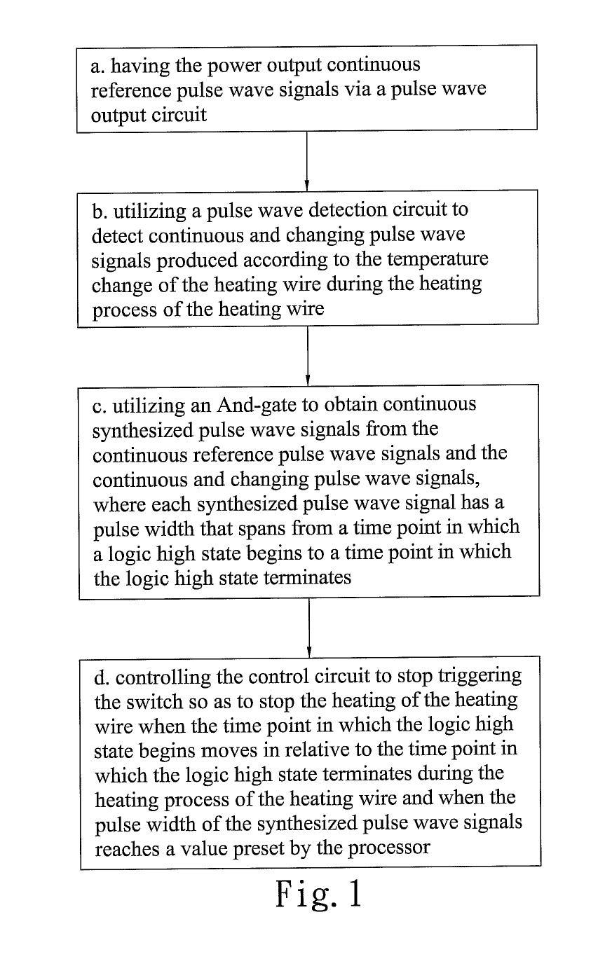

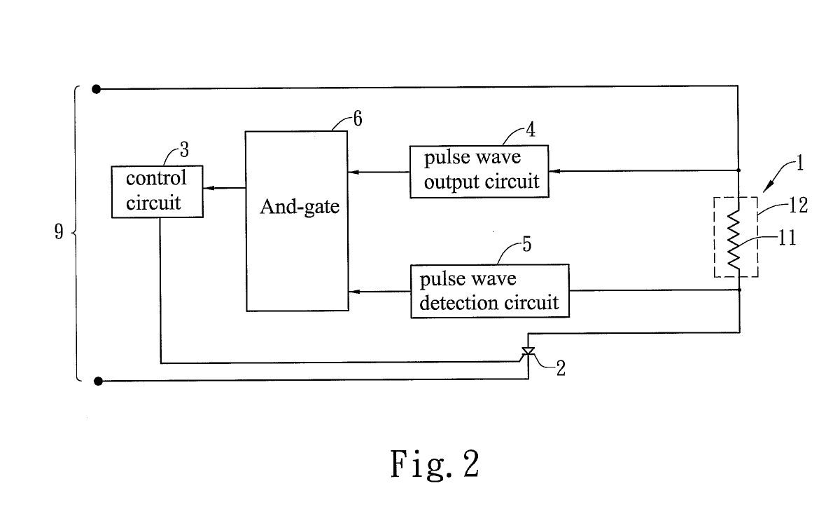

Please refer to FIGS. 1-2. In the temperature control method for a heating line according to the present invention, the heating line 1 includes a heating wire 11 and an insulation-and-meltable layer 12 covering the peripheries of the heating wire 11. One end of the heating wire 11 is coupled with one polarity of a power 9 while another end of the heating wire 11 is connected with a switch 2, and the switch 2 is coupled with a reverse polarity of the power 9. The switch 2 is in conducting or disconnecting condition by means of the control of a control circuit 3 having a processor. The temperature control method for a heating line comprises steps of:
a. having the power 9 output continuous reference pulse wave signals via a pulse wave output circuit 4;
b. utilizing a pulse wave detection circuit 5 to detect continuous and changing pulse wave signals produced according to the temperature change of the heating wire 11 during the heating process of the heating wire 11;
c. utilizing an And-gate 6 to obtain continuous synthesized pulse wave signals from the continuous reference pulse wave signals and the continuous and changing pulse wave signals, where each synthesized pulse wave signal has a pulse width W that spans from a time point T1 in which a logic high state begins to a time point T2 in which the logic high state terminates; and
d. controlling the control circuit 3 to stop triggering the switch 2 so as to stop the heating of the heating wire 11 when the time point T1 in which the logic high state begins moves in relative to the time point T2 in which the logic high state terminates during the heating process of the heating wire 11 and when the pulse width of the synthesized pulse wave signals reaches a value W1 preset by the processor.

In this case, the heating wire 11 is a positive temperature coefficient (PTC) conducting wire. However, the heating wire 11 also can be a negative temperature coefficient (NTC) conducting wire, so as to increase or decrease the resistance when the temperature rises during the heating process.

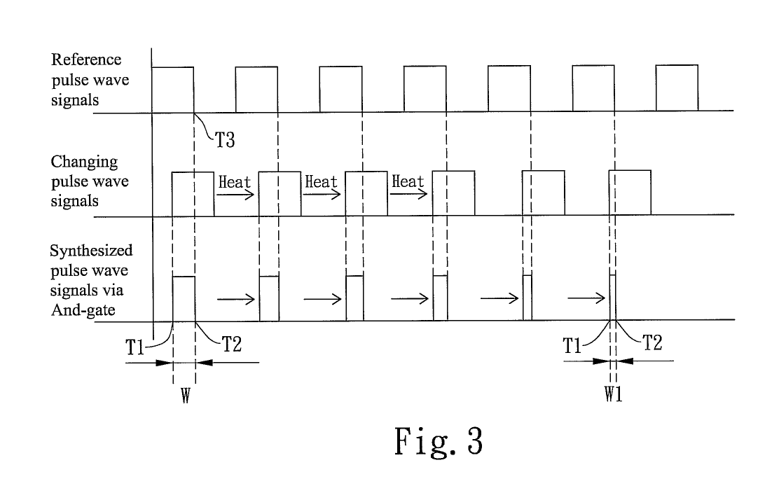

As shown in FIGS. 2-3, the heating wire is a positive temperature coefficient (PTC) conducting wire. In this case, the pulse wave output circuit 4 is connected with the power 9 for continuously outputting the forward reference pulse wave signals. When the temperature of the heating wire 11 rises as the result of the heating, the resistance of the heating wire 11 increases, which will be detected by the pulse wave detection circuit 5 to form continuous and changing forward pulse wave signals. In this moment, the continuous reference pulse wave signals and the continuous and changing forward pulse wave signals are synthesized by the And-gate 6 to form continuous synthesized pulse wave signals.

Each synthesized pulse wave signal has a pulse width W. The width W spans from a time point T1 in which a logic high state begins to a time point T2 in which the logic high state terminates. As to the synthesized pulse wave signals synthesized by And-gate, the time point T2 in which the logic high state terminates for the synthesized pulse wave signal is immovable. When the temperature of the heating wire 11 rises, the time point T1 in which a logic high state begins will move toward the time point T2 in which the logic high state terminates. In this way, the pulse width W of each synthesized pulse wave signal will decrease gradually until it reaches to the pulse width W1 of the synthesized pulse wave signal preset by the processor. Consequently, the control circuit stops triggering the switch 2 to stop the heating of the heating wire 11. When the temperature of the heating wire 11 declines, the time point T1 in which a logic high state begins will gradually move away from the time point T2 in which the logic high state terminates. In other words, the pulse width W of each synthesized pulse wave signal will increase gradually until it reaches to the pulse width W of the synthesized pulse wave signal preset by the processor. Consequently, the control circuit 3 will trigger the switch 2 again to restore the heating of the heating wire 11.

If the heating wire 11 is a negative temperature coefficient (NTC) conducting wire, the pulse width W of each synthesized pulse wave signal will increase with the increase of the temperature of the heating wire 11. When the temperature of the heating wire 11 decreases, the pulse width W of each synthesized pulse wave signal will decrease as well. In this way, when the pulse width reaches the value of the pulse width W1 of the synthesized pulse wave signal preset by the processor, it is able to stop or continue the heating of the heating wire 11 in order to keep the temperature within a preset range.

Moreover, the present invention further comprises a step for temperature adjustment by means of adjusting the time point T3 in which the logic high state terminates for any reference pulse wave signal. For example, the time point T3 in which the logic high state terminates is moved rightward. In this case, because the control circuit will not trigger switch until the same pulse width W is reached, it is able to make adjustment to increase the temperature at which the heating of the heating wire is stopped in order to adjust the temperature range.

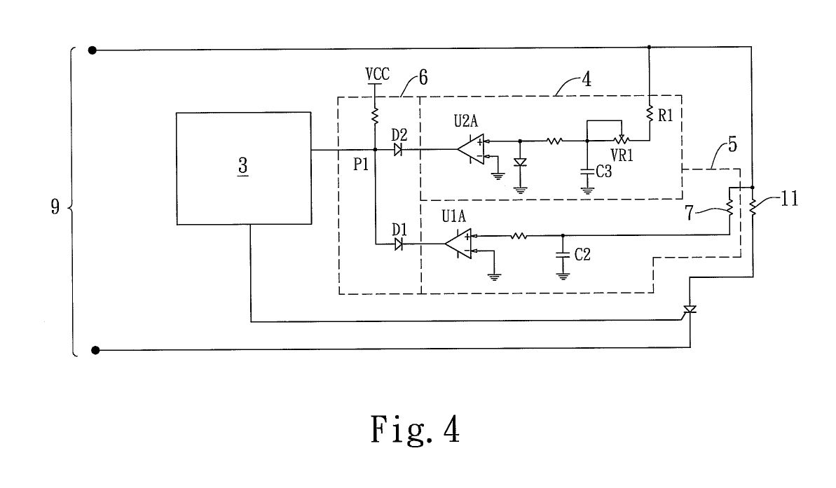

In this embodiment, the pulse wave detection circuit 5 is used to detect directly the resistance change of the heating wire 11. As shown in FIG. 4, the pulse wave detection circuit 5 can utilize a temperature sensing element 7 to detect the temperature change of the heating wire 11. The temperature sensing element 7 can be a sensing line or a thermo-sensitive resistor, both of which can be used to detect heating wire 11. By means of the voltage comparison, it is able to produce continuous and changing pulse wave signals.

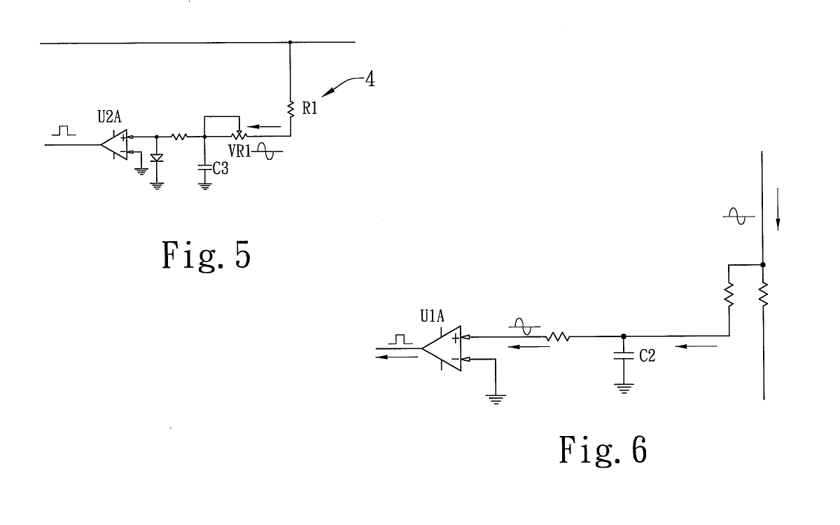

Please refer to FIGS. 4-6, circuit diagrams according to the present invention are illustrated. The pulse wave output circuit 4 includes a resistor R1, a variable resistor VR1, and a second voltage comparator U2A all of which are in serial connection. One end of the resistor R1 is connected to the power 9. The variable resistor VR1 is connected to the non-reverse input end of the second voltage comparator U2A. The reverse input end of the second voltage comparator U2A is connected to ground. Bedsides, the variable resistor VR1 and a capacitor C3 form a RC circuit used to convert the sine wave signals of the power 9 into forward pulse wave signals.

As shown in FIG. 6, the pulse wave detection circuit 5 includes a RC circuit formed by a sensing line and a capacitor C2. Because the RC circuit has the property of RC time constant, the input of the sine wave signals from the alternating current power 9 will be delayed. After these signals are under the voltage comparison via a first voltage comparator U1A, continuous and changing forward pulse wave signals can be output.

The And-gate 6 includes a first diode D1 and a second diode D2 both of which are in parallel connection. The negative pole of the first diode D1 is connected to the output end of the first voltage comparator U1A. The positive pole of the first diode D1 is connected to the power 9. Besides, a first node P1 is provided between the first diode D1 and the power 9. The positive pole of the second diode D2 is coupled to the output end of the second voltage comparator U2A. The negative pole of the second diode D2 is coupled with the first node P1.

Thereby, the continuous reference pulse wave signals and the continuous and changing pulse wave signals can be synthesized by the And-gate 6 to produce continuous synthesized pulse wave signals. By means of adjusting the variable resistor VR1, it is able to adjust the time point T3 in which the in which the logic high state terminates for any reference pulse wave signal and consequently to adjust the heating temperature.

In implementation, the And-gate can be replaced by any microprocessor with the same function. Besides, the switch 2 is a thyristor, such as a SCR or a TRIAC.

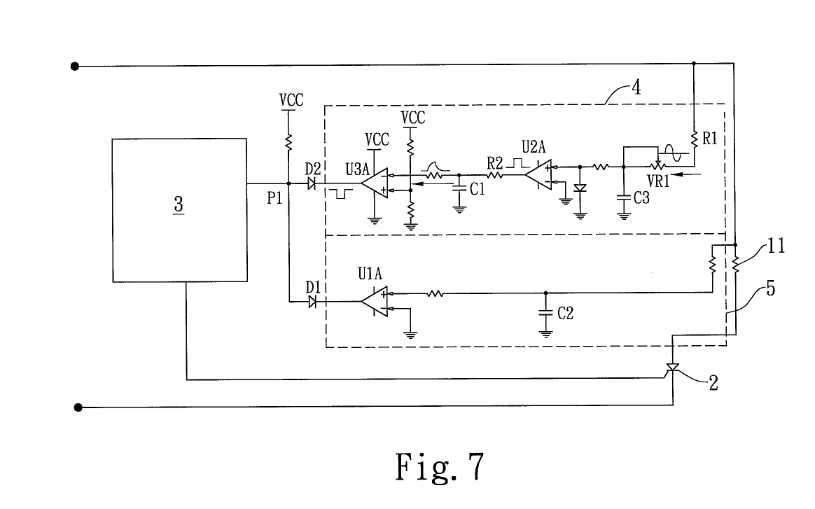

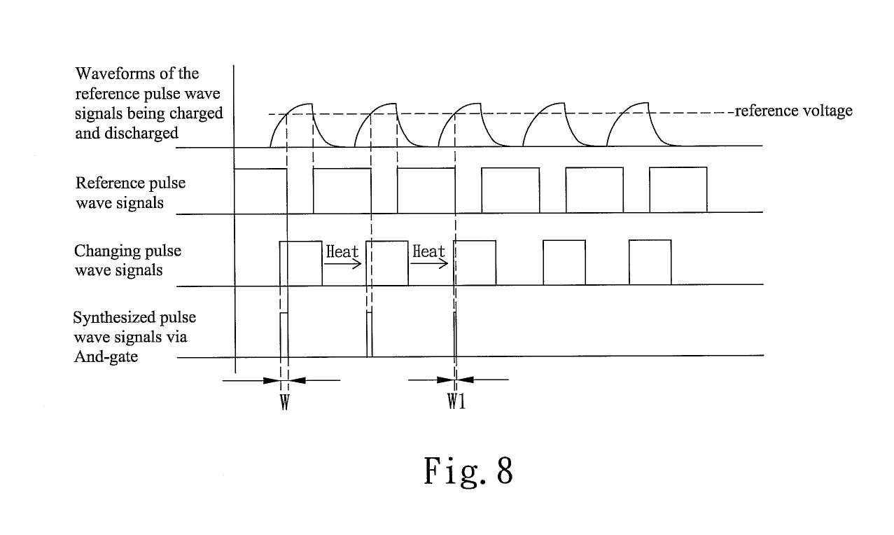

Please refer to FIGS. 7-8, circuits are illustrated therein. Compared with aforementioned circuits, the circuits in FIGS. 7-8 are different in following points. The output end of the second voltage comparator U2A is connected to a RC circuit formed by a resistor R2 and the capacitor C1. The RC circuit is connected to the reverse input end of a third voltage comparator U3A. The non-reverse input end of the third voltage comparator U3A is connected to ground via a resistor. Thereby, when the output end of the second voltage comparator U2A outputs forward pulse wave signals, these signals are charged and discharged via the RC circuit and then input into the third voltage comparator U3A. The input partial voltage via the third voltage comparator U3A is used as reference voltage for comparison. Consequently, it is able to output reverse pulse wave signals.

Thereby, it is also able to obtain the continuous synthesized pulse wave signals from the continuous and changing forward pulse wave signals (that are output after being under the voltage comparison via the first voltage comparator U1A of the pulse wave detection circuit 5) and the continuous reverse reference pulse wave signals (that are output via the third voltage comparator U3A of the pulse wave output circuit 4). Besides, when the pulse width W of the synthesized pulse wave signals reaches the value of the pulse width W1 for synthesized pulse signals preset by the processor, it will prevent the control circuit 3 from triggering the switch 2 and consequently stop the heating of the heating wire 11.

Therefore, the present invention has following advantages:

1. According to the present invention, the heating of the heating line is controlled by the detection of the pulse width of a synthesized pulse wave signal. Consequently, it is able to keep effectively the temperature within a certain range, to simplify the structure, and to reduce manufacturing cost.
2. According to the present invention, the temperature at which the heating of the heating wire is stopped can be adjusted by making adjustment to the time point in which the logic high state terminates for a continuous reference pulse wave signal and by detecting the pulse width of a synthesized pulse wave signal. Consequently, users are capable of adjusting the working temperature to a much greater extent.

As disclosed in above descriptions and attached drawings, the present invention provides a temperature control method for a heating line, which is effective to control the temperature, has simple structure, and has reduced manufacturing cost. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A temperature control method for a heating line, where the heating line includes a heating wire and an insulation-and-meltable layer covering the peripheries of the heating wire; one end of the heating wire is coupled with one polarity of a power while another end of the heating wire is connected with a switch, and the switch is coupled with a reverse polarity of the power; the switch is in conducting or disconnecting condition by means of the control of a control circuit having a processor; the temperature control method comprising steps of
a. having the power output continuous reference pulse wave signals via a pulse wave output circuit;
b. utilizing a pulse wave detection circuit to detect continuous and changing pulse wave signals produced according to the temperature change of the heating wire during the heating process of the heating wire;
c. utilizing an And-gate to obtain continuous synthesized pulse wave signals from the continuous reference pulse wave signals and the continuous and changing pulse wave signals, where each synthesized pulse wave signal has a pulse width that spans from a time point in which a logic high state begins to a time point in which the logic high state terminates; and
d. controlling the control circuit to stop triggering the switch so as to stop the heating of the heating wire when the time point in which the logic high state begins moves in relative to the time point in which the logic high state terminates during the heating process of the heating wire and when the pulse width of the synthesized pulse wave signals reaches a value preset by the processor.

2. The temperature control method for a heating line as claimed in claim 1, further comprising a step for temperature adjustment by means of adjusting the time point in which the logic high state terminates for any reference pulse wave signal in order to control the temperature at which the heating of the heating wire is stopped.

3. The temperature control method for a heating line as claimed in claim 2, wherein the pulse wave output circuit includes a variable resistor fir adjusting the time point in which the logic high state terminates for any reference pulse wave signal.

4. The temperature control method for a heating line as claimed in claim 1, wherein the heating wire is a positive temperature coefficient (PTC) or a negative temperature coefficient (NTC).

5. The temperature control method for a heating line as claimed in claim 4, wherein in step b, the pulse wave detection circuit utilizes a temperature sensing element to detect the temperature change of the heating wire, so as to produce continuous and changing pulse wave signals by means of voltage comparison.

6. The temperature control method for a heating line as claimed in claim 5, wherein the pulse wave detection circuit utilizes a first voltage comparator for voltage comparison; and a non-reverse input end of the first voltage comparator is coupled with the temperature sensing element while a reverse input end of the first voltage comparator is connected to ground.

7. The temperature control method for a heating line as claimed in claim 5, wherein the temperature sensing element is a sensing line.

8. The temperature control method for a heating line as claimed in claim 7, wherein the pulse wave detection circuit utilizes a first voltage comparator for voltage comparison; and a non-reverse input end of the first voltage comparator is coupled with the temperature sensing element while a reverse input end of the first voltage comparator is connected to ground.

9. The temperature control method for a heating line as claimed in claim 2 further comprising a step for temperature adjustment by means of adjusting the time point in which the logic high state terminates for any reference pulse wave signal in order to control the temperature at which the heating of the heating wire is stopped.

10. The temperature control method for a heating line as claimed in claim 9, wherein the pulse wave output circuit includes a variable resistor fir adjusting the time point in which the logic high state terminates for any reference pulse wave signal.

11. The temperature control method for a heating line as claimed in claim 2, wherein the And-gate includes a first diode and a second diode that are in parallel connection; the negative pole of the first diode is connected with the output end of the first voltage comparator while the positive pole of the first diode is connected with the power; a first node is provided between the first diode and the power; and the positive pole of the second diode is coupled with the output end of the second voltage comparator while the negative pole of the second diode is coupled with the first node.
